(19) United States
(12) Patent Application Publication
(10) Pub. No.: US 2012/0009426 A1
(43) Pub. Date: Jan. 12, 2012

(54) Loaded Polymer

(75) Inventors: Mo Song, Loughborough (GB); Dongyu Cai, Loughborough (GB)

(73) Assignee: LOUGHBOROUGH UNIVERSITY, Loughborough, Leicestershire, GB (GB)

(21) Appl. No.: 13/257,589

(22) PCT Filed: Mar. 16, 2010
(86) PCT No.: PCT/GB2010/050448

§ 371 Date: Sep. 19, 2011

(30) Foreign Application Priority Data
Mar. 18, 2009 (GB) 09046343

(51) Int. Cl. C08K 3/34; B32B 1/00

(52) U.S. Cl. 428/404; 524/445

(57) ABSTRACT

A polymer composition that is loaded with clay is made by a process comprising the steps of: providing a mixture of a liquid, such as water, and clay, in which the clay is dispersed in the liquid, and treating the mixture to ensure that the clay is exfoliated; contacting particles of polymer with the mixture of liquid and exfoliated clay, at an elevated temperature at which the surface of the polymer particles is modified to enhance adhesion of the clay to the polymer particles; then separating the resulting polymer particles from the liquid; and then subjecting the separated polymer particles to a processing step to form a polymer/clay composition. The exfoliation of the clay may be ensured by ultrasonic treatment of the liquid and clay mixture, and by having a low concentration of clay in the liquid. The final composition, which may be formed by extrusion, has clay platelets distributed throughout the polymer.

The present invention relates to a process for producing a polymer that is loaded with clay, and to a polymer that can be made by this process.

Various ways have been proposed for combining polymers with clays. However known methods for loading a polymer can lead to a significant impairment of the mechanical properties of the polymer, and may not achieve optimum distribution of clay particles within the polymer.

According to the present invention there is provided a process for producing a polymer that is loaded with clay, the process comprising the steps of:

a) providing a mixture of a liquid and clay, in which the clay is dispersed in the liquid, and treating the mixture to ensure that the clay is exfoliated;
b) contacting polymer in a particulate form with the mixture of liquid and exfoliated clay, at an elevated temperature at which the surface of the polymer particles is modified to enhance adhesion of the clay to the polymer particles; and
c) then separating the resulting polymer particles from the liquid.

The separated polymer particles containing exfoliated clay adhered to their surfaces may then be subjected to a processing step to form a polymer/clay composition, for example compression moulding, injection moulding, or extrusion. Extrusion subjects the material to shear, so that the exfoliated clay platelets are distributed substantially uniformly throughout the polymer, whereas compression moulding merely compresses and bonds the particles together without disrupting the coating of clay to the same extent.

Where such extrusion is carried out the result is a polymer in which clay particles are dispersed. This can for example be a thin film. Surprisingly this can have considerably better barrier properties than can be achieved with the same loading of clay achieved in conventional ways. It will be appreciated that clay typically comprises alumino-silicates that have a sheet-like or layered structure. For example montmorillonite clay forms stacks of platelets each of which is of thickness of the order of 1 nm, but of width approximately 200 nm. Other types of clay have platelets of different sizes, and the separation of the layers in a stack differs for different clays; the widths of platelets are typically between 50 nm and 500 nm. Each particle of clay comprises such a stack. If the platelets of the stack are separated from each other then the material is referred to as being exfoliated. The extent to which the clay has been exfoliated, in the final composition, can be monitored for example by X-ray scattering.

The particles of polymer may be introduced in the first stage, by combining all three components, and then treating the mixture to ensure that the clay is dispersed; or alternatively the clay may be combined with the liquid and this mixture treated to ensure that the clay particles are dispersed, and the polymer particles can then be added and mixed to provide the required mixture. In either case the dispersion and exfoliation of the clay particles may be enhanced by subjecting the mixture containing clay and the liquid to intense ultrasound.

It will also be appreciated that the mixture may in addition contain other filler materials or additives, which may modify the final mechanical properties. For example it may contain finely powdered materials such as chalk or talc, which can act as a bulking agent.

The particle size of the particulate polymer is preferably in the size range corresponding to a powder, and so typically in the range 0.3 μm up to about 600 μm, more typically between 20 μm and 300 μm, for example between 50 μm and 150 μm. Thus the mean particle size would typically be in the range between 0.3 μm and 600 μm. However it is also applicable to larger particles, for example granular particles of sizes in the range between about 500 μm and 2 mm, or larger particles that may be referred to as pellets, which may be as large as 10 mm, more typically about 5 mm. Application to powdered polymer is preferable, as this provides a much larger surface area for adhesion of the clay. Alternatively the polymer may be in the form of an emulsion, so that the particles of polymer may be as small as individual polymer molecules.

Any suitable liquid may be used in the process. A suitable liquid should not react adversely with or cause any significant degradation of the polymer or of the clay in the conditions of the process, and must remain liquid at a temperature and pressure suitable for softening the polymer. The liquid should not act as a good solvent for the polymer. The liquid is preferably easily removed from the mixture containing the particulate polymer, after the heating step, using standard liquid-removal techniques such as filtration or evaporation.

The liquid may be an organic liquid, and may be polar or non-polar. Suitable organic liquids include, but are not limited to, toluene, N,N-dimethylformamide, and chloroform. Alternatively water may be used as the liquid. Where water is used, this is preferably at a pH above 7, preferably between pH 7.0 and pH 8.5, and more preferably between pH 8.0 and pH 8.4, for example pH 8.2. More generally, the pH may be between pH 5 and pH 9. Preferably the concentration of clay in the clay and liquid mixture, by weight, is less than 5% and more preferably less than 2%, to reduce the tendency of clay to re-aggregate.

To ensure dispersion of the clay particles in the liquid, and to achieve disaggregation and exfoliation, it may be sufficient to subject the mixture to stirring or shaking, but preferably ultrasonic irradiation is used. This subjects the mixture of clay and liquid to intense ultrasound. It may also be beneficial to include a surfactant in the liquid to enhance and facilitate dispersion. Where the surfaces of the clay platelets have negative charges, or are neutral, then an anionic or non-ionic surfactant would preferably be selected, such as a sodium alkane sulphonate or sodium alkane sulphate. On the other hand, where the surfaces of the clay platelets carry positive charges, a cationic surfactant would preferably be selected, such as a quaternary ammonium surfactant. This process can achieve exfoliation of the clay particles into individual platelets. The ratio of surfactant to clay, by weight, would typically be in the range 0.1 up to 1.0.

Any thermoplastic polymer can be used in the process of the present invention. The polymer may be a homopolymer, copolymer or a blended polymer. By way of example, thermoplastics that would be suitable for use in the present invention include: acrylonitrile butadiene styrene (ABS), acrylic, celluloid, cellulose acetate, ethylene-vinyl acetate (EVA), ethylene vinyl alcohol (EVAL), fluoroplastics (including FEP, PFA, CTFE, PTFE, ECTFE, ETFE), ionomers, acrylic/PVC alloy, polyacetal, polyacrylates, polyacrylonitrile PAN), polyamide (PA), polyamide-imide (PAI), polyaryletherketone (PAEK), polybutadiene (PBD), polybutylene terephthalate (PBT), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, co-polyester, polyolefins such as polyethylene (PE), polypropylene (PP), polybutylene (PB), polymethylpentene (PMP), and olefin-based copolymers, polyetheretherketone (PEEK), polyetherimide (PEI), polyethersulphone (PES), polyethylenechlorinates (PEC), polyimide (PI), polylactic acid (PLA), polyphenylene oxide (PPO), polyphenylene sulphide (PPS), polyphthalamide (PPA), polystyrene (PS), polysulphone (PSU), polyvinylchloride (PVC), polyvinylidenechloride (PVdC), plasticised starches, polyhydroxybutyrate (PHB), and polyvinyl alcohol (PVA or PVOH).

Preferred polymers for use in the invention include nylons, polyethylene, polypropylene, polystyrene, poly(methyl methacrylate), poly(vinyl chloride), poly(vinyl acetate), polycarbonate, polycaprolactone, poly(ethylene oxide), poly(vinyl alcohol), poly(ethylene terephthalate), poly(ether sulphone), poly(butyl terephthalate), poly(ethyl methacrylate), ultrahigh molecular weight polyethylene. Particularly preferred polymers include nylons, polyvinylchlorides, polycaprolactones, styrene-vinyl acetate diblock copolymers, polyolefins such as polypropylene or polyethylene, and olefin-based copolymers.

The particulate polymer may be amorphous, semi-crystalline or crystalline before it is heated. The process is applicable to single polymers and to mixtures of polymers. For example the mixture may be of polymers of the same composition but of different molecular weight, or chemically different polymers.

The mixing steps can be carried out at any suitable temperature, typically between about 0° C. and 80° C., and is typically carried out at ambient temperature (say around 20° C.). Typically the weight of clay, as a proportion of the weight of particulate polymer, is in the range between 1% and 10%, preferably between 1% and 5% and more preferably between 2% and 4%; satisfactory results may also be produced with lower clay proportions, but preferably at least 0.1%, for example 0.3%.

In order to contact the particulate polymer with the liquid and clay mixture at an elevated temperature, the particulate polymer is preferably mixed with the liquid and clay mixture, and this mixture is then heated to the elevated temperature. At the elevated temperature the surface energy of the polymer decreases, so the surfaces of the polymer particles become softer and stickier, and this temperature should be maintained for a sufficient period for the clay particles to adhere to the particle surfaces. Typically this temperature will be above the glass transition temperature for the polymer, in the case of at least partially amorphous polymers where the glass transition temperature is above ambient temperature; and will usually be higher than the temperature at which the mixing steps are carried out, but in some cases the mixing might also be carried out at such an elevated temperature, so that no further heating is required. For other polymers the elevated temperature will be in the vicinity of the melting point, typically within 20° C. below or above the melting point. With some polymers the surfaces of the particles may melt, although the polymer particles remain as discrete particles in suspension in the liquid. The clay particles or platelets that adhere to the surfaces of the polymer particles act as a barrier to prevent polymer particles melting together.

The heating step, with some polymers, aims to achieve a temperature in the range between about 10° C. below the melting point of the polymer up to about 10° C. above the melting point of the polymer. In situations in which melting of the polymer is not desired, the heating may be controlled so that the maximum temperature reached is less than the melting point of the polymer, preferably between about 2° and about 8° C. below the melting point. With some polymers it is not important whether or not the polymer melts, as long as its surface becomes softened. For these applications the heating temperature does not need to be so closely controlled; this is particularly the case for polymers whose surface becomes softened at a temperature significantly below the melting point. If the requisite temperature is above the normal boiling point of the liquid it will be necessary to perform this step at elevated pressure to prevent the liquid from boiling.

It will be appreciated that the elevated temperature must be maintained for sufficient time for the clay particles to adhere to the surfaces of the polymer particles. Typically this will require a period between about 1 minute and 20 minutes, more typically between 5 minutes and 10 minutes. During this period the mixture usually requires agitation to ensure good contact is maintained between the polymer particles and the clay particles. This may for example include stirring or shaking. Increasing the period of time may increase the quantity of clay that adheres to the surfaces, and so improve the barrier properties of the final product.

The separation of the modified polymer particles from the remaining liquid may use any conventional step such as filtration or centrifugation. The liquid may be cooled before this separation step, but this is not essential. It is usually necessary to dry the modified polymer particles, particularly where water has been used as the liquid. This may use warm air drying.

Finally the modified polymer particles may be used to form a final product, or to form pellets that can be subsequently formed into a final product, or may be combined with untreated polymer. This may for example be by extrusion through an extruder die that pelletizes the material. The end result is a material in which clay platelets are dispersed substantially uniformly. A preferred product is a film, in which the clay platelets enhance the barrier properties of the film; where the film is made by extrusion the clay platelets may be oriented parallel to the surface of the film.

The invention also provides polymer particles with exfoliated clay platelets adhered to the surface of the particles. The invention also provides a modified polymer containing distributed exfoliated clay platelets, the clay being highly dispersed and disaggregated. Such polymer particles, and such a modified polymer, can be made by the process of the invention.

It has been found that this modified polymer can have significantly better barrier properties than would be expected from the level of loading of the clay. Without wishing to be bound by theory, it is hypothesised that because the clay is disaggregated and exfoliated in the liquid phase, it remains in this disaggregated and exfoliated state when bound to the polymer, so that the resulting polymer matrix is more homogeneous. Since the level of loading is reduced, the mechanical properties of the polymer can also be expected to be better.

The invention will now be further and more particularly described, by way of example only, and with reference to the following Examples and with reference to the accompanying drawings, in which:

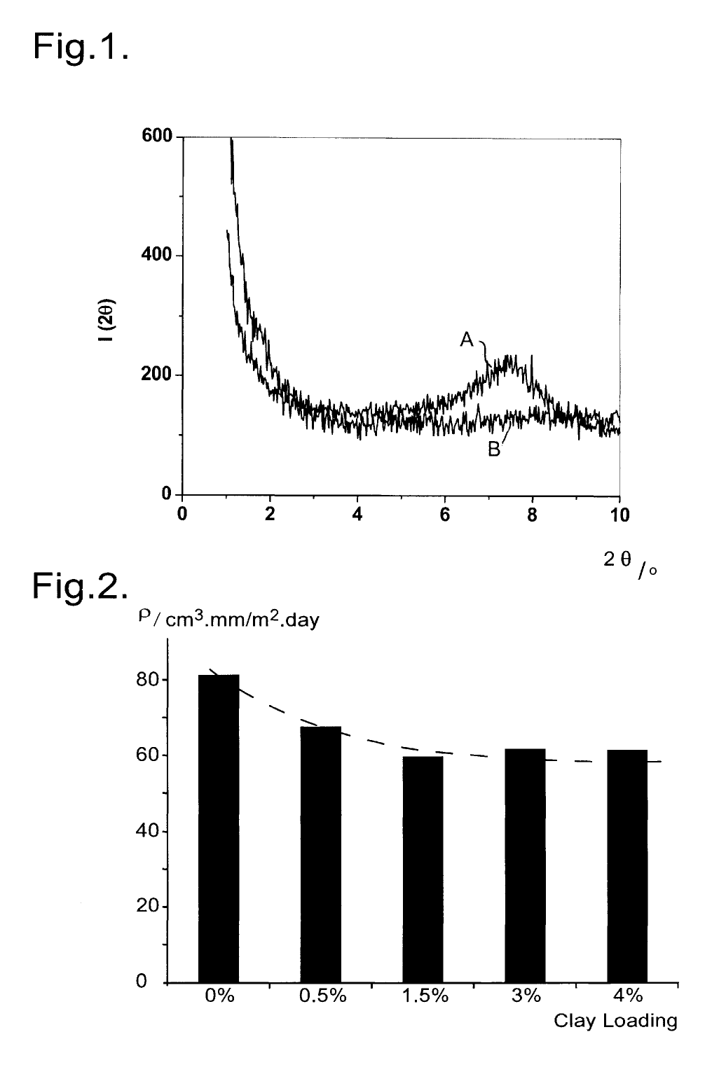

FIG. 1 shows graphically x-ray diffraction patterns with raw clay, and with a polymer incorporating clay made in accordance with the present invention; and

FIG. 2 shows graphically measurements of oxygen permeability for polymer films of the invention.

### EXAMPLE 1

Montmorillonite clay was added to water, in a weight proportion of 2%. The pH was adjusted to pH 8.2 by addition of aqueous sodium hydroxide solution. Montmorillonite clay is negatively charged, so sodium dodecyl sulphate (anionic surfactant) was then added, in a weight proportion of 0.3 relative to the clay, and stirred. To ensure that the clay is both exfoliated and dispersed the mixture was then subjected to intense ultrasound for 10 minutes. This may for example use a 300 W ultrasonic horn at 20 kHz (for example Fisher Scientific Sonic Dismembrator model 500).

The suspension of exfoliated clay was then mixed with twice the initial quantity of water, and polyethylene powder was added, such that the weight ratio of polyethylene powder to clay was 97 to 3. This mixture was stirred vigorously while being heated in a pressure vessel to 121° C. at elevated pressure, and maintained at that temperature for 10 minutes with continuous stirring using a magnetic stirrer. During this period the clay platelets adhere to the surfaces of the polyethylene powder, so there is no longer any clay in suspension. The mixture was then cooled to 50° C. The water was separated from the polyethylene powder/clay using a filter, and the powder mixture was dried in an oven at 65° C. for 12 hours.

The polyethylene powder/clay particles were then introduced into a twin screw compounder (in this case a Collin ZK25) provided with an outlet extrusion slot die to produce a sheet. In the compounding and extrusion process the materials are subjected to mixing and shear at elevated temperatures, the first two zones being at 170° and 190° C. and the remaining zones at 200° C., so that the exfoliated clay and the polyethylene are thoroughly mixed. The compounding screw is rotated at 150 rpm, and the melt pressure at which extrusion occurs is 46 bar. The material emerging from the extrusion die is in the form of a 1 mm thick sheet in which the exfoliated clay is incorporated and dispersed throughout the polyethylene. This is then passed through a set of three chilling and finishing rollers, producing a final film thickness of 0.97 mm.

The polyethylene in this example has a melting point at about 128° C. As indicated above, at a temperature of 121° C. the clay particles adhere to the polymer. In contrast, if the same process is carried out at only 100° C., it has been found that the clay particles do not adhere to the polymer, and so remain in suspension.

In a modification, the above-described process may be performed without the provision of any surfactant.

### EXAMPLE 2

Hydrotalcite clay was added to water, in a weight proportion of 2%. The pH was adjusted to pH 8.2 by adding aqueous sodium hydroxide solution. Hydrotalcite clay is positively charged, so a cationic surfactant dodecyl trimethyl ammonium chloride was then added, in a weight proportion of 0.3 relative to the clay, and stirred. To ensure that the clay is both exfoliated and dispersed the mixture was then subjected to intense ultrasound for 10 minutes. This may for example use a 300 W ultrasonic horn at 20 kHz (for example Fisher Scientific Sonic Dismembrator model 500).

The suspension of exfoliated clay was then mixed with twice the initial quantity of water, and polyethylene powder was added, such that the weight ratio of polyethylene powder to clay was 97 to 3. This mixture was stirred vigorously while being heated in a pressure vessel to 121° C. at elevated pressure, and maintained at that temperature for 10 minutes with continuous stirring using a magnetic stirrer. During this period the clay platelets adhere to the surfaces of the polyethylene powder, so there is no longer any clay in suspension. The mixture was then cooled to 50° C. The water was separated from the polyethylene powder/clay using a filter, and the powder mixture was dried in an oven at 65° C. for 12 hours.

The polyethylene powder/clay particles may be the final product. Alternatively they may be subjected to further treatment, for example being introduced into a twin screw compounder and extruded, as described in Example 1.

### EXAMPLE 3

Montmorillonite clay was added to water, in a weight proportion of 2%, giving a mixture of pH 7.5. To ensure that the clay was both exfoliated and dispersed the mixture was then subjected to intense ultrasound for 10 minutes as in the preceding examples.

The suspension of exfoliated clay was then mixed with particles of a styrene/vinyl acetate block co-polymer, such that the weight ratio of polymer to clay was 97 to 3. The vinyl acetate blocks have a glass transition temperature of about 40° C. This mixture was stirred vigorously while being heated to 100° C., and maintained at that temperature for 10 minutes with continuous stirring using a magnetic stirrer. During this period the clay platelets adhere to the surfaces of the polymer particles in suspension. The mixture was then cooled to 25° C. The water was separated from the polymer/clay by evaporation.

It will be appreciated that the Examples are by way of illustration and explanation of the present invention. They may be modified for example by using different surfactants, different temperatures, and different polymers. By way of example, dodecyl trimethyl ammonium chloride might be replaced by a different cationic surfactant such as cetyl trimethyl ammonium bromide (i.e. hexadecyl trimethyl ammonium bromide), or by a non-ionic surfactant.

Referring now to FIG. 1, this shows X-ray diffraction patterns graphically, showing variation of relative intensity, I, against the angle 2θ. Graph A shows the pattern obtained with refined hectorite clay (Bentone HC(™)) in its original form, for which there is clearly a peak at around θ=7.5° indicative of the layer spacing between platelets in the clay particles. Graph B shows the pattern obtained with a polymer/1.5% clay composition made in accordance with the present invention, and in this case there is clearly no peak, indicating that the platelets have been completely exfoliated. In this case the polymer used was high density polyethylene (HDPE).

Substantially similar patterns were obtained with 2% montmorillonite clay in LDPE. The raw clay was found to provide a diffraction pattern substantially similar to the graph A in FIG. 1, with a peak at about 2θ=7.5°. After 5 minutes insonation of clay in aqueous suspension, and combining the clay with LDPE by the method described in Example 1, the pattern resembled graph B, with no peak being evident, suggesting total exfoliation. The pattern was not significantly different if the clay was subjected to 10 minutes insonation.

### EXAMPLE 4

Refined hectorite clay (Bentone HC(™)) was added to water and then subjected to ultrasonic insonation by pumping the clay/water mixture from a first vessel through an ultrasonic insonation cell and into a second vessel. During its passage through the irradiation cell, and so for a few seconds, the mixture was subjected to an ultrasonic power of 80 W, and the time taken for pumping all the mixture through the insonation cell was around 20-30 minutes. Afterwards LLDPE (linear low-density polyethylene) powder (ICO (™)) was mixed with the clay/water mixture. Four different mixtures were made, with weight proportions of clay from 0.5% up to 4% (relative to the polymer). In each case the mixture was vigorously stirred at a stirring speed of 1700 RPM, to ensure that the polymer powder was thoroughly dispersed. The parameters are as shown in the table:

| Clay loading | Water/kg | Polymer/kg | Insonation/min |
|---|---|---|---|
| 0.5% | 3.0 | 0.6 | 25 |
| 1.5% | 3.0 | 0.6 | 25 |
| 3.0% | 2.4 | 0.4 | 20 |
| 4.0% | 3.2 | 0.4 | 30 |

In each case the water/polymer/clay was then stirred vigorously while being heated in a pressure vessel to 95° C. The stirrer was then removed, and the temperature raised to 121° C. at elevated pressure, and maintained at that temperature for 20 minutes. During this period the clay platelets adhere to the surfaces of the polyethylene powder, so there is no longer any clay in suspension. The mixture was then cooled to 50° C. The water was separated from the polyethylene powder/clay using a filter, and the powder mixture was dried in an oven at 85° C. for 72 hours.

The polyethylene powder/clay particles were then introduced into a twin screw compounder and formed into a thin sheet. Four such sheets were made from each different clay/polymer mixture. Measurements of oxygen permeability were then made on the thin sheets, for the different polymer/clay proportions. For comparison purposes polyethylene powder was subjected to the same processes as described above, but without the addition of clay, and a thin sheet was formed from this polymer powder, to provide control samples.

The experimental results are shown in FIG. 2, to which reference is now made. It will be seen that the oxygen permeability, ρ, for the control samples of LLDPE (without clay) was 81.6 cm³.mm/m².day. All the thin sheets that incorporated clay have lower oxygen permeability, the oxygen permeability decreasing initially as the concentration of clay increases, to 68.2 cm³.mm/m².day with a loading of 0.5%, and then to 60.5 cm³.mm/m².day with a loading of 1.5%, and then remaining substantially constant at the higher clay loadings at about 62.7 cm³.mm/m².day. These results show clearly that the presence of a small quantity of clay dispersed in the polymer significantly decreases oxygen permeability.

It is surmised that the clay in this Example 4 is only partially exfoliated, and that a greater degree of exfoliation and hence a greater reduction in oxygen permeability can be achieved by subjecting the clay/water mixture to ultrasonic irradiation for longer, and possibly at a higher intensity.

It will thus be appreciated that the present invention requires the polymer to be brought into contact, in a liquid suspension, with exfoliated clay particles at an elevated temperature at which the surface energy decreases so that the clay particles adhere to the polymer surface. If the polymer is at least partially amorphous, with a glass transition temperature above ambient temperature, then the elevated temperature at which such adhesion occurs is above the glass transition temperature. In other cases the requisite elevated temperature is typically within 30° C. of the melting point, more typically within 20° C. of the melting point. Once adhesion has occurred, the polymer particles are separated from the liquid and processed to form a product such as a film.

What is claimed:

1. A process for producing a polymer that is loaded with clay, the process comprising the steps of
a) providing a mixture of a liquid and clay, in which the clay is dispersed in the liquid, and treating the mixture to ensure that the clay is exfoliated;
b) contacting polymer in a particulate form with particle sizes in a range between 20 and 300 μm, with the mixture of liquid and exfoliated clay, at an elevated temperature at which the surface of the polymer particles is modified to enhance adhesion of the clay to the polymer particles; and
c) then separating the resulting polymer particles from the liquid.

2. A process as claimed in claim 1 wherein the mixture of the liquid and clay is subjected to ultrasound to ensure the clay is exfoliated.

3. A process as claimed in claim 1 or claim 2 wherein the liquid is water, at a pH that is above pH 7.

4. A process as claimed in claim 3 wherein the pH is between pH 7 and pH 8.5.

5. A process as claimed in claim 3 wherein the water also contains a surfactant.

6. A process as claimed in claims 1 wherein the of the polymer particles is in the size range from 50 μm up to 150 μm.

7. (canceled)

8. A process as claimed in claim 1 wherein the concentration of clay in the mixture of liquid and clay is less than 5% by weight.

9. A process as claimed in claim 1 wherein the polymer is a thermoplastic polymer selected from: nylons, polyethylene, polypropylene, polystyrene, and in the poly(methyl methacrylate), poly(vinyl chloride), poly(vinyl acetate), polycarbonate, polycaprolactone, poly(ethylene oxide), poly(vinyl alcohol), poly(ethylene terephthalate), poly(ether sulphone), poly(butyl terephthalate), poly(ethyl methacrylate), and ultrahigh molecular weight polyethylene.

10. A process as claimed in claim 1 wherein the polymer particles are mixed with the mixture of liquid and clay, and this mixture is then heated to the elevated temperature.

11. A process as claimed in claim 1 wherein the elevated temperature is above the glass transition temperature for the polymer, for at least partially amorphous polymers whose glass transition temperature is above ambient temperature.

12. A process as claimed in claim 1 wherein the elevated temperature is held for sufficient time for the clay particles to adhere to the surfaces of the polymer particles.

13. A process as claimed in claim 1 also comprising the additional step of:
d) subjecting the separated polymer particles to a processing step to form a polymer/clay composition.

14. A process as claimed in claim 13 wherein the processing step comprises extrusion through an extruder die.

15. A polymer in particulate form with particle sizes in a range between 20 μm and 300 μm loaded with exfoliated clay platelets that adhere to the surfaces of the polymer particles.
